(19) United States
(12) Patent Application Publication
(10) Pub. No.: US 2005/0052737 A1
(43) Pub. Date: Mar. 10, 2005

(54) Optical sheet and process for producing the same

(76) Inventors: Hiroyuki Amemiya, Tokyo-to (JP); Hideaki Yamagata, Tokyo-to (JP); Hiroyuki Ohtaki, Tokyo-to (JP)

Correspondence Address: HARNESS, DICKEY & PIERCE, P.L.C., P.O. BOX 828, BLOOMFIELD HILLS, MI, 48303, US

(21) Appl. No.: 10/936,966

(22) Filed: Sep. 9, 2004

(30) Foreign Application Priority Data
Sep. 9, 2003 (JP) 2003-316841
Sep. 24, 2003 (JP) 2003-332349

(51) Int. Cl. G03B 21/60

(52) U.S. Cl. 359/456

(57) ABSTRACT

Disclosed are a fine-pitch and lightweight optical sheet and a production process which can produce the optical sheet very easily at low cost. The optical sheet comprises an optical function layer formed of a thermoplastic resin. The optical function layer has been formed by shaping the surface of the thermoplastic resin into cylindrical lenses, and the pitch of the shaped cylindrical lenses is not more than 150 μm.

### BACKGROUND OF THE INVENTION

1. Field of the Invention

The present invention relates to an optical sheet and a process for producing the optical sheet. More particularly, the present invention relates to a cylindrical lens-shaped optical sheet and a lenticular lens sheet for a transmission screen.

2. Background Art

Various optical sheets have hitherto been proposed. For example, in transmission screen sheets, particularly diffusive sheets for transmission screens for projection televisions, shaping of the surface thereof into lenses has been carried out.

In such diffusive sheets for transmission screens, in general, at least one side of a sheet formed of a transparent or semitransparent material is formed into a lenticular shape while a striped light shielding layer is provided on the other side of the sheet.

Regarding techniques in connection with such optical sheets, for example, Japanese Patent Laid-Open No. 338606/2000, Japanese Patent Laid-Open No. 209131/2001, Japanese Patent Laid-Open No. 174859/2002, and Japanese Patent Laid-Open No. 303709/2002 disclose that a resin composition formed into a lenticular shape is polymerized and cured by applying an ionizing radiation such as a radiation, ultraviolet light, or electron beams. This method utilizing an ionizing radiation for polymerization and curing of the resin is advantageous in that the shape of the mold can be very faithfully reproduced on the surface of the molded product.

Since, however, radiation curing resins and photosensitive resins are relatively expensive, the production cost of optical lens sheets is increased. Further, when there is damage to the mold, disadvantageously, the damage is also of course faithfully reproduced on the surface of the molded product. In general, the damage to the mold often occurs in an acute-angle tip part of the mold (that is, for example, in the mold for lenticular lens, the damage occurs in the concave part of the lenticular lens). For this reason, a production technique utilizing extrusion using a thermoplastic resin instead of the ionizing radiation curing resin has been desired. Specifically, the development of a technique utilizing a thermoplastic resin is desired in which the damage to the mold is less likely to be reflected in the final molded product, whereby a deterioration in optical properties can be prevented.

In recent years, an increase in quality of image representation and an increase in size of screens have led to a demand for optical sheets which can produce high-definition images and can be produced easily at low cost. In diffusive sheets for transmission screens, narrowing the pitch of the lens element, that is, the adoption of fine pitch, is a method effective for producing high-definition images. The pitch of a light shielding layer provided on the other side of the sheet corresponds to the pitch of the lenses. Therefore, the pitch of the light shielding layer should be narrowed with decreasing the pitch of the lenticular lenses.

When lenses are molded by a conventional extrusion method using a thermoplastic resin, however, finer pitch than a given level cannot be realized without difficulties due to limitation derived from processing accuracy of the lenticular lens side. Specifically, lenses can be relatively stably provided at a pitch of about 500 μm, whereas lenses at a finer pitch (for example, not more than 200 μm) than about 500 μm cannot be provided without difficulties.

Further, when lenses are shaped by applying high pressure for the formation of a thinner sheet, in some cases, an optical function layer having a lens shape is disadvantageously broken.

Conventional methods proposed for forming a striped light shielding part include the so-called “wet process” which comprises coating a light shielding toner or a black ink onto a photosensitive pressure-sensitive adhesive layer, exposing the coating, washing nonexposed areas with water to remove the light shielding toner and the like from the nonexposed area, and a dry process utilizing a cationic polymerization reaction in a photosensitive pressure-sensitive adhesive.

The photosensitive pressure-sensitive adhesive utilizing the cationic polymerization reaction, however, suffers from high material cost, and short pot life which makes it difficult to handle during processing.

### SUMMARY OF THE INVENTION

Accordingly, an object of the present invention is to provide an optical sheet, which has a fine pitch and is lightweight as a light diffusive sheet or a lenticular lens sheet for a transmission screen, and a production process which can produce the optical sheet very easily at low cost.

According to a first aspect of the present invention, there is provided an optical sheet comprising an optical function layer formed of a thermoplastic resin, said optical function layer having been formed by shaping the surface of the thermoplastic resin into cylindrical lenses, the pitch of the shaped cylindrical lenses being not more than 150 μm.

According to a second aspect of the present invention, there is provided a process for producing the above optical sheet, said process comprising the steps of:
a) extruding and delivering a molten thermoplastic resin continuously onto a substrate film being moved;
b) pressing a molding roll against the thermoplastic resin provided on the substrate film to transfer a shaping pattern on the surface of the molding roll onto the thermoplastic resin and thus to shape the surface of the thermoplastic resin into cylindrical lenses, and continuously delivering a laminate structure of the shaped thermoplastic resin and the substrate film; and
c) subsequently curing the shaped thermoplastic resin and then optionally separating the substrate film from the assembly.

According to a third aspect of the present invention, there is provided a lenticular lens sheet for a transmission screen, said lenticular lens sheet comprising (A) a transparent or a semitransparent sheet formed of a thermoplastic resin, (B) a photosensitive pressure-sensitive adhesive layer, (C) a light shielding part, (D) an adhesive layer, and (E) a transparent or semitransparent support formed of a thermoplastic resin which have been successively formed in that order,
said sheet (A) having cylindrical lenses with a pitch of not more than 150 μm on one side of the sheet, and having a sheet thickness of not more than 200 μm,
said light shielding part (C) being in the form of a stripe having a width of not more than 130 μm.

According to a fourth aspect of the present invention, there is provided a process for producing a lenticular lens sheet for a transmission screen, said process comprising the steps of:
a) transferring a shaping pattern onto a molten extruded thermoplastic resin to prepare a not more than 200 μm-thick transparent or semitransparent sheet (A) with cylindrical lenses being shaped therein at a pitch of not more than 150 μm;
b) forming a photosensitive pressure-sensitive adhesive layer (B) on the transparent or semitransparent sheet (A), formed in step (a), on the flat side which is opposite to the cylindrical lenses;
c) applying light at a collimation angle of not more than 10 degrees to the sheet, prepared in step (b), on its side where the cylindrical lenses are formed, whereby the adhesive strength of the photosensitive pressure-sensitive adhesive in its part exposed to light focused by the cylindrical lenses is lowered by a radical reaction;
d) laminating a light shielding layer transfer sheet comprising a material for light shielding part formation onto the photosensitive pressure-sensitive adhesive layer in the sheet prepared in step (c);
e) separating the light shielding layer transfer sheet laminated in step (d) to transfer the material for light shielding part formation onto the unexposed part in the photosensitive pressure-sensitive adhesive layer (B), thereby forming a striped light shielding part; and
f) forming an adhesive layer (D) and a transparent or semitransparent support (E) formed of a thermoplastic resin on the sheet prepared in step (e).

In the present invention, since neither a radiation curing resin nor a photosensitive resin is used in the lens part, an optical sheet (a lenticular lens sheet for a light transmission screen) can be produced at low cost.

Further, since the optical function layer (a layer provided with cylindrical lenses) is formed of a thermoplastic resin, the damage to the mold is less likely to be reflected in the final molded product and, as a result, a deterioration in optical properties can be prevented.

Furthermore, in the present invention, the so-called “extrusion emboss lamination molding is used in which the supply and transfer of the substrate film, extrusion in which the supply of a thermoplastic resin and surface shaping are carried out, and a lamination step are carried out continuously. Therefore, the thickness of the optical function layer of the optical sheet can be rendered thin.

Further, a fine-pitch and light-weight optical sheet can be produced as a light diffusive sheet or lenticular lens sheet for a transmission screen very easily at low cost.

In the lenticular lens sheet for an optical transmission screen according to the present invention, a lenticular lens sheet for an optical transmission screen provided with cylindrical lenses at a fine pitch of not more than 150 μm can be realized by forming the cylindrical lens layer using a thermoplastic resin and rendering the thickness of the cylindrical lens layer small.

### BRIEF DESCRIPTION OF THE DRAWINGS

FIG. A1 is a typical cross-sectional view of an optical sheet which is a preferred embodiment of the present invention;

FIG. A2 is a typical cross-sectional view of an optical sheet which is a preferred embodiment of the present invention;

FIG. A3 is a typical cross-sectional view of an optical sheet which is a preferred embodiment of the present invention;

FIG. A4 is a typical cross-sectional view of an optical sheet which is a preferred embodiment of the present invention;

FIG. A5 is a perspective view of the optical sheet shown in FIG. A1;

FIG. A6 is a perspective view of the optical sheet shown in FIG. A4;

FIG. A7 is a schematic diagram illustrating a production process of an optical sheet according to the present invention;

FIG. A8 is a schematic diagram illustrating another embodiment of the production process of an optical sheet according to the present invention;

FIG. B1 is a typical cross-sectional view of a lenticular lens sheet for a transmission screen in a preferred embodiment of the present invention;

FIG. B2 is a schematic diagram of an embodiment of an apparatus used in the production process of a lenticular lens sheet for a transmission screen according to the present invention;

FIG. B3 is a schematic cross-sectional view showing an embodiment of a sheet prepared in step (b) according to the present invention;

FIG. B4 is a schematic cross-sectional view showing an embodiment of a sheet prepared in step (e) according to the present invention; and

FIG. B5 is a schematic diagram of another embodiment of an apparatus used in the production process of a lenticular lens sheet for a transmission screen according to the present invention.

### DETAILED DESCRIPTION OF THE INVENTION

The present invention will be described, if necessary, with reference to the accompanying drawings.

1. Optical Sheet According to First Aspect of the Invention

FIGS. A1 to A4 are schematic cross-sectional views of preferred embodiments of the optical sheet according to the present invention. FIG. A5 is a perspective view of the optical sheet according to the present invention shown in FIG. A1.

An optical sheet (1) according to the present invention shown in FIG. A1 is an optical sheet comprising a substrate film layer (2) and an optical function layer (3) formed of a thermoplastic resin. The optical function layer (3) is a layer formed by shaping the surface of the thermoplastic resin into cylindrical lenses, and the pitch of the shaped cylindrical lenses is not more than 150 μm. The optical sheet according to the present invention may not be provided with the substrate film layer (2).

The optical sheet (1) shown in FIG. A1 is particularly suitable for an optical sheet for constituting a light diffusive sheet in a transmission screen for projection televisions.

Details (for example, constituents, surface state or form of the shaped surface and thickness) of the cylindrical lenses as the optical function layer (3) can be properly determined according to the applications of the optical sheet (1) of the present invention. The thickness of the optical function layer (3) (that is, distance between the flat face on the substrate film layer (2) side and the apex of the convex in the lens) is not more than 150 μm, particularly not more than 100 μm. The shaped surface may not be necessarily such that regular patterns are continuously arranged.

The substrate film layer (2) may be formed of various thermoplastic resins and thermosetting resins so far as they have properties required of the substrate for an optical sheet, for example, transparency, strength, durability and the like. Preferred thermoplastic resins include polyethylene terephthalate (PET), polystyrene (PS), polycarbonate (PC), polymethyl methacrylate (PMMA), polyvinyl chloride (PVC), polyethylene (PE), tetrafluoroethylene (PTFE), and copolymer resins containing at least one of these resins.

The thickness of the substrate film layer (2) may be properly determined depending upon specific applications of the optical sheet and the strength and the like required of the optical sheet. In the present invention, the thickness of the substrate film layer may be 25 to 150 μm, preferably 50 to 100 μm.

The optical function layer (3) is formed by extruding a molten thermoplastic resin onto the substrate film layer (2) and has a shaped surface. The thermoplastic resin constituting the optical function layer (3) has good transparency, strength, and durability, and, at the same time, can be extruded and shaped with good stability and operability, and can provide a predetermined optical function.

Such thermoplastic resins include polystyrene (PS), polycarbonate (PC), polymethyl methacrylate (PMMA), polyvinyl chloride (PVC), polyethylene (PE), tetrafluoroethylene (PTFE), polypropylene (PP), and copolymer resins containing at least one of these resins.

Among the above thermoplastic resins, resins having a softening temperature of 80 to 180° C., particularly 90 to 150° C., are preferred. The term “softening temperature” as used herein refers to a Vicat softening temperature as measured by the method specified in JIS K 7206.

Preferably, the thermoplastic resin has a coefficient of linear expansion of not more than 9×10⁻⁵/° C. Here the coefficient of linear expansion refers to a value as measured by the method specified in JIS K 7197.

Further, preferably, the thermoplastic resin has a water absorption of not more than 0.3%, particularly preferably not more than 0.2%. Here the water absorption refers to a value as measured by the method specified in JIS K 7209.

Among the thermoplastic resins in the above preferred embodiments, the thermoplastic resin having a coefficient of linear expansion of not more than 9×10⁻⁵/°C. is more preferred.

As compared with the conventional radiation curing resins and photosensitive resins, the thermoplastic resin used in the present invention are much more inexpensive and does not always require the use of a photopolymerization initiator or the like. Therefore, neither coloration of the resin attributable to the photopolymerization initiator or the like nor a lowering in transparency occurs. This enables an optical sheet having excellent transparency, color tone reproduction, and stability to be produced at low cost.

When the above thermoplastic resin is used, a slight thermal resilience phenomenon is sometimes observed in the shaped surface of the thermoplastic resin layer. In the present invention, even when some damage to the surface of a molding roll used in shaping is present, the use of the thermoplastic resin permits the reproduced damage to the shaped surface of the optical function layer (3) to be repaired by the thermal resilience and thus to be rendered visually unnoticeable. Thus, an improvement in optical properties can be realized. When the optical function layer is provided at a fine pitch for high-quality image representation, the above effect is significant.

In the production process of an optical sheet according to the present invention, a method may be adopted in which the thermoplastic resin is previously palletized and the pellets are melted and used in the production of the optical sheet. For example, when additives (for example, light diffusing agents and colorants) are mixed in a thermoplastic resin or when two or more thermoplastic resins are used, the resin composition can be suitably regulated by mixing previously prepared pellets together and melting the mixture, or by mixing pellets in a molten resin and melting the mixture. The regulation can be suitably carried out even when the difference in specific gravity between the mixing ingredients is large or even when the viscosity of the resin is relatively high.

FIGS. A2 to A4 are schematic cross-sectional views of optical sheets in other preferred embodiments of the present invention. FIG. A6 is a perspective view of the optical sheet according to the present invention shown in FIG. A4.

In an optical sheet (1) according to the present invention shown in FIG. A2, an adhesive layer (4) is interposed between the substrate film layer (2) and the optical function layer (3).

In an optical sheet (1) according to the present invention shown in FIG. A3, a striped light shielding layer (6) is provided through a pressure-sensitive adhesive layer (5) on the substrate film layer (2) which is opposite to the optical function layer (3). A construction may also be adopted in which the pressure-sensitive adhesive layer (5) is omitted and the striped light shielding layer (6) is provided directly on the substrate film layer (2). Further, a construction may also be adopted in which the substrate film layer (2) is omitted and the pressure-sensitive adhesive layer (5) or the striped light shielding layer (6) is directly provided.

In an optical sheet (1) according to the present invention shown in FIG. A4, a support (8) is provided through an adhesive layer (7) on the striped light shielding layer (6). A construction may also be adopted in which the adhesive layer (7) is omitted and the support (8) is provided directly on the light shielding layer (6). Regarding the pressure-sensitive adhesive layer (5) in its parts on which the striped light shielding layer (6) is not provided, the adhesive layer (7) is provided directly on the pressure-sensitive adhesive layer (5) (when the adhesive layer (7) is omitted, the support (8) is provided directly on the pressure-sensitive adhesive layer (5)).

In the optical sheet (1) shown in FIG. A2 or FIG. A4, the adhesive layer (4, 7) may be formed of any material so far as satisfactory adhesive strength is provided between the adhesive layer (4, 7) and layers in contact with the adhesive layer (4, 7) (for example, the substrate film layer (2), the optical function layer (3), the pressure-sensitive adhesive layer (5), the light shielding layer (6), and the support (8)) and, in addition, the material has substantially no adverse effect on each layer and the function, properties and the like of the optical sheet per se.

The thickness of the adhesive layer (4, 7) may be determined by taking into consideration, for example, the material of each layer constituting the optical sheet and the necessary adhesive strength. The adhesive layer (4) which functions to adhere the optical function layer (3) to the substrate film layer (2) may be formed of an isocyanate, vinyl acetate or the like, and the adhesive layer (7) which functions to adhere the light shielding layer (6) to the support (8) may be formed of a urethane resin, acrylic resin, epoxy resin or the like.

When the optical function layer (3) is in the form of lenticular lenses as shown in FIG. A3, the light shielding layer (6) is formed in a region through which light focused by the lenses is not to be passed. In the optical sheet (1) shown in FIGS. A1 to A4, light is incident from the lower side of the optical sheet (1), is focused by the optical function layer 3, and is then passed, toward above the optical sheet (1), through a region where the light shielding layer (6) is not provided. The region impermeable to light focused by the optical function layer (3) is provided in a stripe form corresponding to the shaped surface of the optical function layer (3). Therefore, the light shielding layer (6) also becomes a stripe form. Preferably, the light shielding layer (6) may be formed of a black light shielding material, for example, carbon black, black ink, or black toner.

The ratio of the striped light shielding layer (6) to the lens pitch (b in FIG. A3) is preferably 50 to 90%. According to the present invention, since an optical sheet with the light shielding layer (6) provided at this high ratio is provided, a high-quality image can be realized.

The light shielding layer (6) can be formed by various methods. In the present invention, the light shielding layer (6) may be formed by forming a pressure-sensitive adhesive layer (a pressure-sensitive adhesive layer 5) which causes disappearance or a lowering of tackiness upon-exposure to light (mainly ultraviolet irradiation) on the substrate film (2), allowing light (mainly ultraviolet light) focused by the optical function layer (3) to act on the pressure-sensitive layer (5) to cause disappearance or a lowering of tackiness of the pressure-sensitive adhesive layer (5) in its region through which light is to be passed, and then coating a light shielding layer forming material (for example, finely-powdered carbon black or black ink) to adhere the light shielding layer forming material onto only the pressure-sensitive adhesive layer (5) in its tacky region (that is, light impermeable parts).

The pressure-sensitive adhesive layer (5) may be formed of, for example, a material prepared by mixing a radical reaction initiator into a radically reactive resin material.

In the optical sheet (1) according to the present invention, as shown in FIG. A4, if necessary, the support (8) may be provided. The support (8) may be any one. Preferably, however, the support (8) has a saturated water absorption elongation of not more than 0.3%, particularly preferably not more than 0.2%. Resins satisfying this requirement include methyl methacrylate-styrene copolymer (MS resin).

Further, in the optical sheet according to the present invention, a light diffusing function can be imparted to at least one layer constituting the optical sheet (1). The light diffusing function can be imparted by adding a light diffusing agent (for example, acrylic beads, styrene beads, or glass beads) to any of the layers.

In the optical sheet according to the present invention, at least one layer (preferably, any one or at least two layers of the substrate sheet layer (2), the optical function layer (3), the support (8), and other layers (not shown)) constituting the optical sheet (1) may have a nonglare, antistatic, or contamination-resistant property.

In the optical sheet (1) according to the present invention shown in FIGS. A1 to A4, for example, a nonglare layer, an antistatic layer, and/or a contamination-resistant layer (not shown) may be additionally provided according to need.

2. Production Process of Optical Sheet According to Second Aspect of Invention

FIG. A7 is a schematic diagram of a preferred embodiment of the production process of an optical sheet according to the present invention.

The production process of an optical sheet according to the present invention shown in FIG. A7 comprises the steps of:
a) extruding and delivering a molten thermoplastic resin continuously onto a substrate film being moved;
b) pressing a molding roll against the thermoplastic resin provided on the substrate film to transfer a shaping pattern on the surface of the molding roll onto the thermoplastic resin and thus to shape the surface of the thermoplastic resin into cylindrical lenses, and continuously delivering a laminate structure of the shaped thermoplastic resin and the substrate film; and
c) subsequently curing the shaped thermoplastic resin and then separating the substrate film from the assembly to produce said optical sheet or providing said optical sheet without the separation of the substrate film.

Carrying out steps a) to c) consecutively in that order in a part of the whole process suffices for the production process of an optical sheet according to the present invention. Therefore, for example, other step(s) or procedure(s) may be carried out before carrying out step a) or after carrying out step c), or, if necessary, between consecutive two steps of steps a) to c).

Each step will be described.

(1) Step (a)

In the production process of an optical sheet according to the present invention shown in FIG. A7, a substrate film (10) is supplied from a substrate film supply source (14) and is moved leftward from the substrate film supply source (14). The substrate film (10) comes into contact with a pressing roll (18), is moved on the roll surface part in the pressing roll (18) in accordance with the rotation of the pressing roll (18), is then passed through a press contact point (19) between the pressing roll (18) and a molding roll (12), and is moved according to the rotation of the molding roll (12) in such a state that the thermoplastic resin layer and the substrate film are stacked on top of each other.

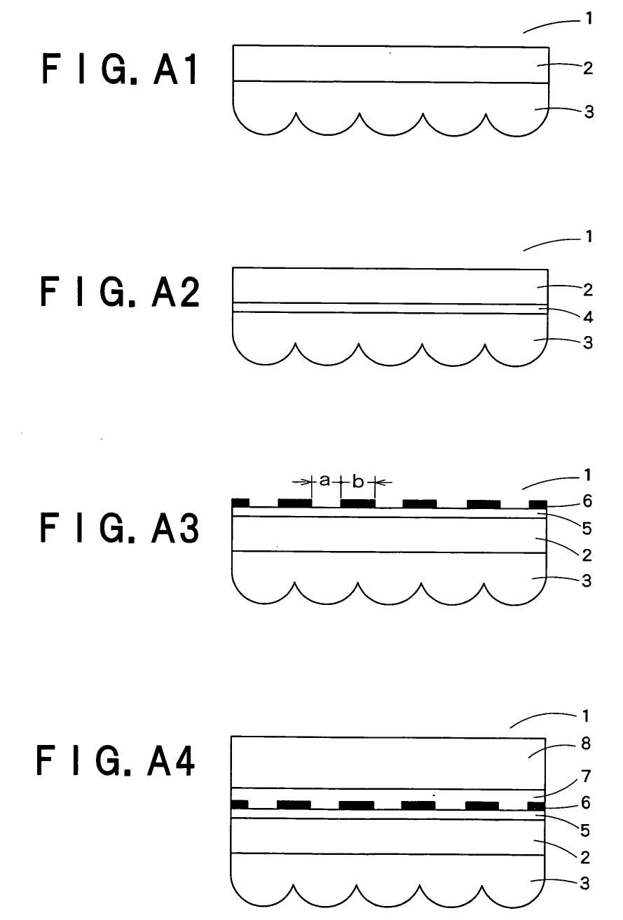

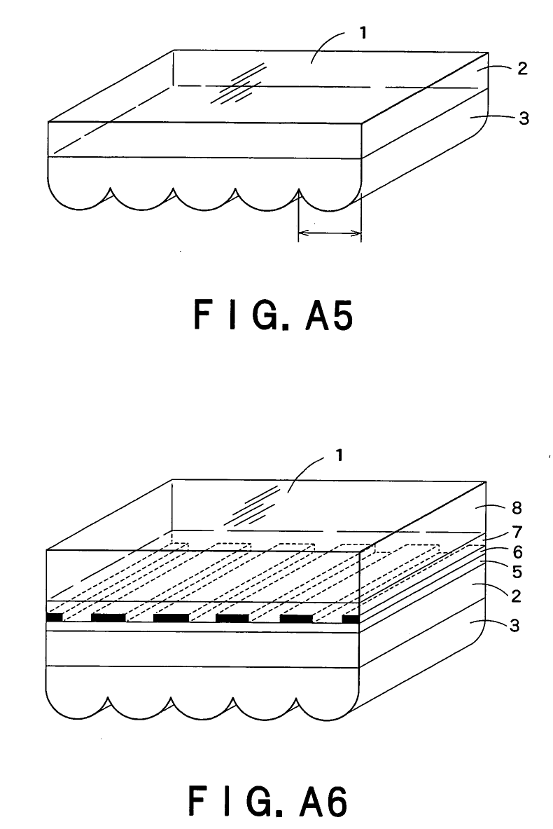

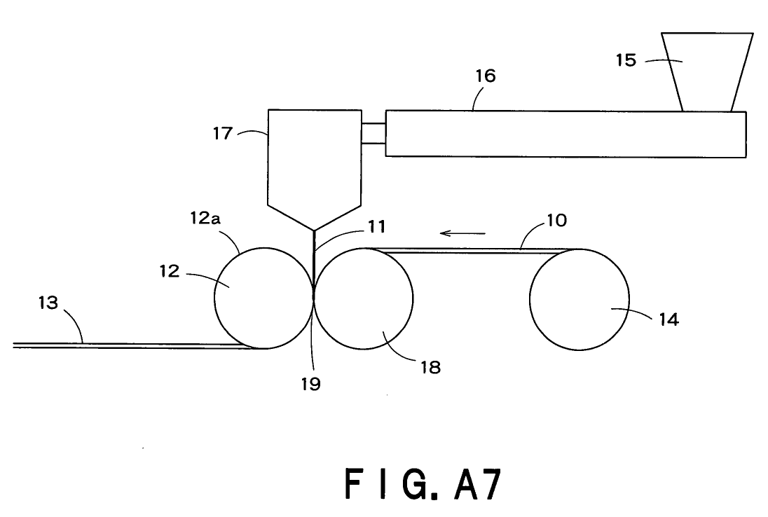

When the optical sheet having the adhesive layer (4) as shown in FIG. 2A is produced, a laminate comprising an adhesive layer provided on a substrate film may be provided in the substrate film supply source (14).

The thermoplastic resin constituting the optical function layer (3) in the optical sheet according to the present invention is supplied, for example, as pellets from a hopper (15) into a barrel (16) where the resin is heated to a predetermined temperature. The resin is then continuously supplied in a molten state through a die (17) onto a substrate film (10) being moved.

The thermoplastic resin may be continuously supplied so as to come into contact simultaneously with the substrate film and the molding roll. The amount of the molten thermoplastic resin supplied may be properly determined by taking into consideration, for example, the quantity of movement of the substrate film (10), the thickness of the optical function layer, and the shape of molded cylindrical lenses.

(2) Step (b)

In the production process of an optical sheet according to the present invention shown in FIG. A7, a molding roll (12) is pressed against the thermoplastic resin (11) on the substrate film (10) to transfer the shaped pattern (12a) of the surface of the molding roll (12) to the thermoplastic resin (11), whereby the thermoplastic resin (11) is shaped into lenses. The shaped pattern (12a) may be determined so that a predetermined shaped surface is formed in the optical function layer.

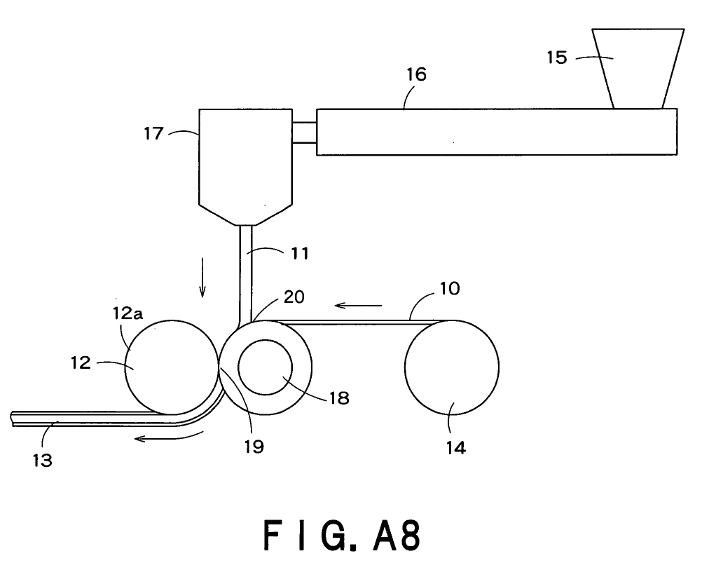

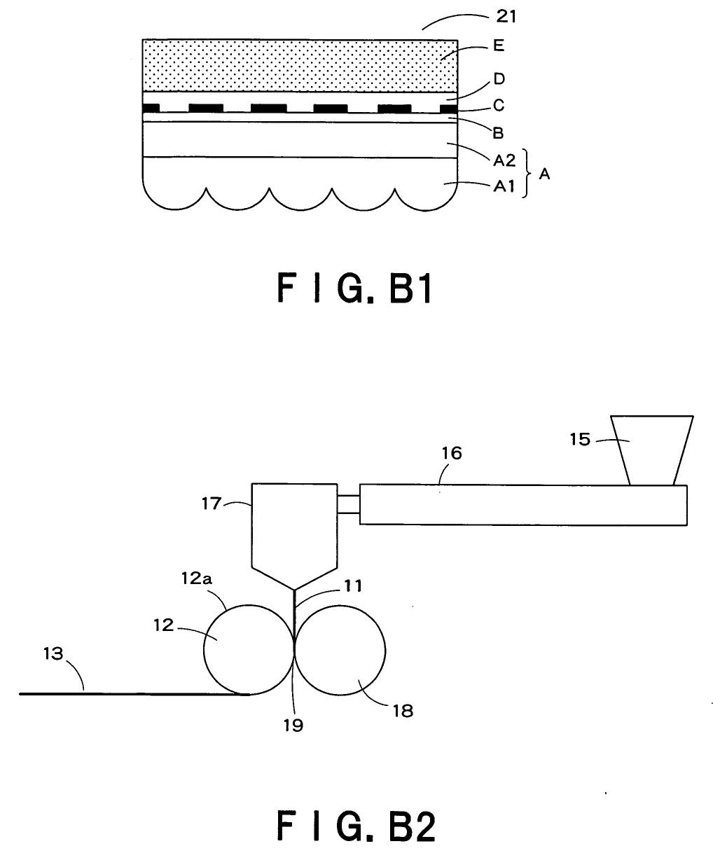

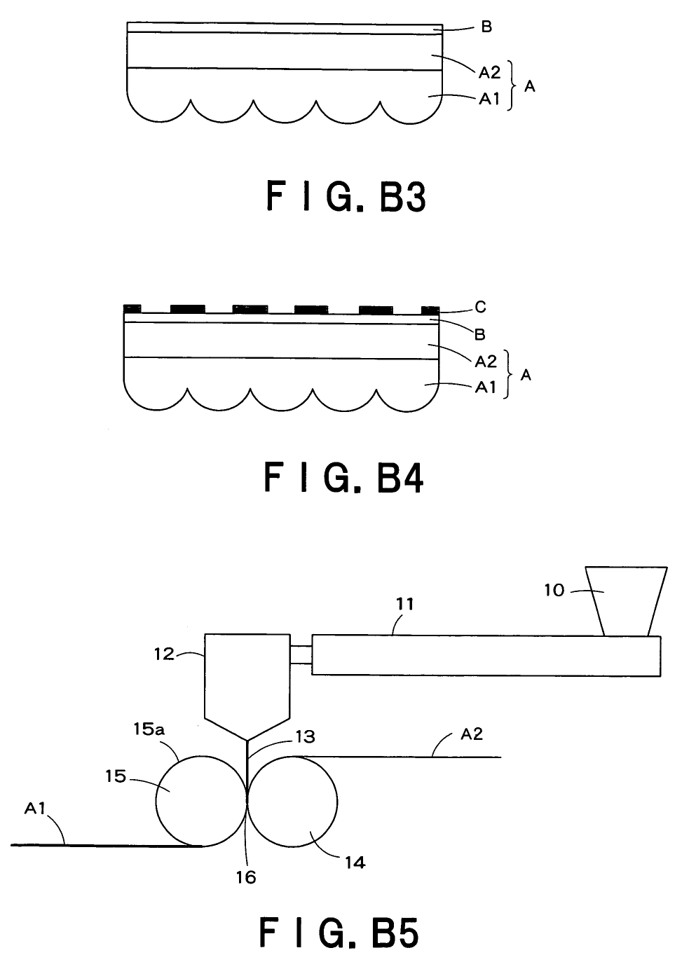

The molding roll (12) continuously delivers a laminate (13) of the molded thermoplastic resin (11) and the substrate film (10). The substrate film (10) and the thermoplastic resin (11) are simultaneously supplied into between the molding roll (12) and the pressing roll (18) provided opposite to the molding roll (12) and, at the same time, are molded and extruded in a continuous manner. The shaped pattern (12a) in this molding roll (12) may be provided so that the direction of movement of the substrate film (10) (a direction indicated by an arrow in FIG. 7) is parallel to the direction of lens convex part (or the lens concave part) of cylindrical lenses. Alternatively, a construction may be adopted in which the direction of movement of the substrate film (10) is orthogonal to the direction of the lens convex part (or the lens concave part) of the cylindrical lenses. In the present invention, preferably, the direction of movement of the substrate film (10) is parallel to the direction of the lens convex part (or the lens concave part) of the cylindrical lenses.

The radius of the molding roll (12) is not necessarily identical to and may be different from the radius of the pressing roll (18). The molding roll (12) and the pressing roll (18) each may be provided with temperature control means, and the temperature of both the rolls may also be regulated to respective optical ranges so that a good optical sheet can be provided.

(3) Step (c)

In step (c), the thermoplastic resin (11) shaped into lenses is cured. After curing the thermoplastic resin, the substrate sheet may be separated to prepare an optical sheet consisting of the thermoplastic resin layer alone. After step (c), other layer(s) (for example, a light shielding layer) may be formed.

3. Production Process of Optical Sheet According to Other Aspect of Invention

FIG. A8 is a schematic diagram of the production process of an optical sheet according to other aspect of the present invention.

The production process of an optical sheet according to the present invention shown in FIG. A8 comprises the steps of:
a) extruding and delivering a molten thermoplastic resin continuously onto a substrate film being moved;
b) pressing a molding roll against the thermoplastic resin provided on the substrate film to transfer a shaping pattern on the surface of the molding roll onto the thermoplastic resin and thus to shape the surface of the thermoplastic resin into cylindrical lenses, and continuously delivering a laminate structure of the shaped thermoplastic resin and the substrate film; and
c) subsequently curing the shaped thermoplastic resin and then separating the substrate film from the assembly to produce said optical sheet or providing said optical sheet without the separation of the substrate film,
the molten thermoplastic resin in step a) being supplied to a position on the upstream side of the direction of supply of the substrate film as compared with the pressing position of the molding roll in step b).

As shown in FIG. A8, preferably, the molten thermoplastic resin is supplied to a position (20) on the substrate film (10) being moved and on the upstream side of the direction of supply of the substrate film (10) (that is, substrate film supply source (14) side) as compared with the molding roll (12) pressing position. In general, a reservoir part called “bulk” of the molten thermoplastic resin occurs around the press contact point (19) part between the pressing roll (18) and a molding roll (12) in accordance with the relationship between the extrusion output of the thermoplastic resin supplied from the die (17) onto the substrate film (10) and the amount of the thermoplastic resin shaped into the cylindrical lenses by the molding roll (12). In the present invention, the molten thermoplastic resin is supplied to the position (20) on the upstream side of the direction of supply of the substrate film (10) compared with the position of the bulk.

It is estimated that, in this bulk part, a local change in viscosity, properties, and flow direction of the thermoplastic resin occurs, for example, due to the weight of the molten thermoplastic resin per se, the movement of the substrate film (10), suction caused by the rotation of the pressing roll (18) and the molding roll (12), and a pressure change and a temperature change caused by shaping. In the present invention, the reason why the thickness of the optical function layer can be reduced and cylindrical lenses having a fine pitch of not more than 150 μm can be realized is considered to reside in that the properties and state of the thermoplastic resin during molding can be optimized for cylindrical lens molding by supplying the molten thermoplastic resin to a specific position.

In the present invention, the so-called “extrusion emboss lamination molding,” in which the supply and transfer of the substrate film, extrusion of a thermoplastic resin, and a lamination step are carried out continuously, is used. Therefore, the thickness of the optical function layer of the optical sheet can be rendered thin, and an optical sheet with cylindrical lenses having a pitch of not more than 150 μm unattainable by the prior art technique can be provided.

Further, the optical sheet can be produced using an inexpensive thermoplastic resin in a continuous and stable manner. Therefore, the production efficiency is high, and the cost effectiveness is good.

4. Lenticular Lens Sheet for Transmission Screen According to Third Aspect of Invention

FIG. B1 is a typical cross-sectional view of a lenticular lens sheet for a transmission screen in a preferred embodiment of the present invention.

A lenticular lens sheet (21) for a transmission screen according to the present invention shown in FIG. B1 is a lenticular lens sheet for a transmission screen, said lenticular lens sheet comprising (A) a transparent or a semitransparent sheet formed of a thermoplastic resin, (B) a photosensitive pressure-sensitive adhesive layer, (C) a light shielding part, (D) an adhesive layer, and (E) a transparent or semitransparent support formed of a thermoplastic resin which have been successively formed in that order,
said sheet (A) having cylindrical lenses with a pitch of not more than 150 μm on one side of the sheet and having a thickness of not more than 200 μm,
said light shielding part (C) being in the form of a stripe having a width of not more than 130 μm.

The lenticular lens sheet (21) for a transmission screen shown in FIG. B1 is particularly suitable as a lenticular lens sheet in a transmission screen for projection televisions.

The construction of the lenticular lens sheet for a transmission screen will be described.

(1) Transparent or Semitransparent Sheet

In the transparent or semitransparent sheet (A), the pitch of the cylindrical lenses is preferably not more than 150 μm, particularly preferably 50 to 100 μm. The thickness of the transparent or semitransparent sheet (A) is preferably not more than 200 μm, particularly preferably 50 to 150 μm.

FIG. B1 shows a transparent or semitransparent sheet (A) composed of a cylindrical lens layer (A1) and a substrate film layer (A2). This transparent or semitransparent sheet (A) composed of the cylindrical lens layer (A1) and the substrate film layer (A2) is a preferred embodiment of the present invention. In the present invention, however, the transparent or semitransparent sheet (A) may consist of the cylindrical lens layer (A1) alone.

(2) Cylindrical Lens Layer

The thermoplastic resin for cylindrical lens formation has good transparency, strength, and durability, and, at the same time, can be extruded and shaped with good stability and operability. Such thermoplastic resins include polystyrene (PS), polycarbonate (PC), polymethyl methacrylate (PMMA), polyvinyl chloride (PVC), polyethylene (PE), tetrafluoroethylene (PTFE), polypropylene (PP), and copolymer resins containing at least one of these resins.

The shape of the cylindrical lenses can be properly determined depending upon a light source. Preferably, the cylindrical lenses have a lens pitch of not more than 150 μm, particularly preferably 50 to 100 m, from the viewpoint of moire caused between the shape and single light source pixels.

(3) Substrate Film Layer

The substrate film layer (A2) may be formed of various thermoplastic resins and thermosetting resins so far as they have properties required of the substrate for an optical sheet, for example, transparency, strength, durability and the like. Preferred thermoplastic resins include polyethylene terephthalate (PET), polystyrene (PS), polycarbonate (PC), polymethyl methacrylate (PMMA), polyvinyl chloride (PVC), polyethylene (PE), and tetrafluoroethylene (PTFE).

(4) Photosensitive Pressure-sensitive Adhesive Layer

The photosensitive pressure-sensitive adhesive layer (B) preferably causes a lowering in adhesive strength of the exposed part by a radical reaction and is preferably formed of a photosensitive adhesive which, upon exposure to light, causes, in its exposed part, a lowering in adhesive strength of not less than 50% as compared with the adhesive strength of the unexposed part.

The photosensitive pressure-sensitive adhesive comprises at least a pressure-sensitive adhesive resin, a photopolymerizable compound, and a photopolymerization initiator.

Pressure-sensitive adhesive resins include acrylic resins, gum resins, silicone resins, urethane resins, and polyester resins. Among them, acrylic pressure-sensitive adhesives having excellent durability and adhesion are preferred.

The acrylic pressure-sensitive adhesive resin is composed mainly of an acrylic copolymer resin produced by copolymerizing an alkyl acrylate with other monomer and a functional monomer.

In the alkyl acrylate, the number of carbon atoms in the alkyl group is preferably 4 to 15. Examples of such alkyl acrylates include n-butyl acrylate, 2-ethylhexyl acrylate, isooctyl acrylate, and isononyl acrylate. They may be used either solely or as a mixture of two or more.

Other monomers usable herein include methyl acrylate, methyl methacrylate, styrene, acrylonitrile, and vinyl acetate. They may be used either solely or as a mixture of two or more.

Functional monomers usable herein include, for example, acrylic acid, methacrylic acid, itaconic acid, hydroxyethyl acrylate, hydroxyethyl methacrylate, propylene glycol acrylate, acrylamide, methacrylamide, glycidyl acrylate, glycidyl methacrylate, dimethylaminoethyl methacrylate, and tert-butylaminoethyl methacrylate. They may be used either solely or as a mixture of two or more.

An acrylic copolymer resin having on its side chain a photoreactive group, for example, an unsaturated double bond, may also be used. Specifically, photoreactive group-containing resins described in Japanese Patent Laid-Open No. 355678/2000 may be used.

In the acrylic copolymer resin, the ratio among the alkyl acrylate, the other monomer(s), and the functional monomer is preferably 70 to 99 (% by weight) for the alkyl acrylate, 0 to 20 (% by weight) for the other monomer(s), and 0.01 to 20 (% by weight) for the functional monomer, more preferably 80 to 95 (% by weight) for the alkyl acrylate, 0 to 10 (% by weight) for the other monomer(s), and 0.1 to 15 (% by weight) for the functional monomer. The weight average molecular weight of the acrylic copolymer resin is 200,000 to 1,200,000, preferably 400,000 to 1,000,000.

The acrylic pressure-sensitive adhesive may comprise, in addition to the acrylic copolymer resin, a room temperature crosslinking-type or heat crosslinking-type crosslinking agent from the viewpoint of improving cohesive force. Further, a tackifier and the like may be added to the acrylic pressure-sensitive adhesive from the viewpoint of modifying the adhesive strength, tackiness, and viscoelasticity.

Upon aging of the acrylic pressure-sensitive adhesive under room temperature conditions, the room temperature crosslinking-type crosslinking agent causes a crosslinking reaction of the acrylic pressure-sensitive adhesive. Specific examples of room temperature crosslinking-type crosslinking agents include polyisocyanate compounds of polyvalent isocyanates, trimers of these polyisocyanate compounds, isocyanate-terminated urethane prepolymers produced by reacting the above polyisocyanate compounds with polyol compounds, polyisocyanate compounds of these urethane prepolymers, and trimers of these polyisocyanate compounds. Specific examples of polyvalent isocyanates include 2,4-tolylene diisocyanate, 2,5-tolylene diisocyanate, 1,3-xylylene diisocyanate, 1,4-xylylene diisocyanate, diphenylmethane-4,4′-diisocyanate, 3-methyidiphenylmethane diisocyanate, hexamethylene diisocyanate, isophorone diisocyanate, dicyclohexylmethane-4,4′-diisocyanate, dicyclohexylmethane-2,4′-diisocyanate, and lysine isocyanate. Chelate compounds of metals such as aluminum and titanium and polyfunctional epoxy compounds may also be used as the crosslinking agent.

The room-temperature crosslinking-type crosslinking agent is preferably added in an amount of 0.005 to 20 parts by weight, particularly 0.01 to 10 parts by weight, based on 100 parts by weight of the acrylic copolymer resin.

Preferably, the heat crosslinking-type crosslinking agent causes a crosslinking reaction of the acrylic pressure-sensitive adhesive upon heating of the acrylic pressure-sensitive adhesive to 100° C. or above, preferably 130° C. or above for 1 to 30 min. Specific examples of such heat crosslinking-type crosslinking agents include methylol group-containing compounds produced by reacting formaldehyde with melamine, benzoguamine, urea or the like, and etherification products of a part or the whole of the methylol group thereof with aliphatic alcohols. The heating crosslinking-type crosslinking agent is preferably added in an amount of 0.01 to 25 parts by weight, particularly preferably 0.1 to 20 parts by weight, based on 100 parts by weight of the acrylic copolymer resin.

The tackifier is optionally added for improving the tackiness of the acrylic pressure-sensitive adhesive. Tackifiers include rosin resins, terpene resins, and xylene resins. The tackifier is preferably in an amount of not more than 50% by weight, particularly preferably not more than 40% by weight, to the acrylic pressure-sensitive adhesive.

Photopolymerization compounds may be classified according to polymerization type, for example, into photoradically polymerizable compounds, photocationically polymerizable compounds, photoanionically polymerizable compounds, and compounds which initiates polymerization through photodimerization. Among them, photoradically polymerizable compounds are preferred from the viewpoints of the range of selectable materials, polymerizability and the like.

Photoradically polymerizable compounds include compounds having at least one addition polymerizable ethylenically unsaturated double bond. Specific examples of photoradically polymerizable compounds include unsaturated carboxylic acids and salts thereof, esters of unsaturated carboxylic acids with aliphatic polyhydric alcohol compounds, and amide bonded products between unsaturated carboxylic acids and aliphatic polyamine compounds. More specific examples thereof include monomers of esters of aliphatic polyhydric alcohol compounds with unsaturated carboxylic acids. Acrylic esters include, for example, ethylene glycol diacrylate, triethylene glycol diacrylate, 1,3-butanediol diacrylate, tetramethylene glycol diacrylate, propylene glycol diacrylate, neopentyl glycol diacrylate, trimetylolpropane triacrylate, trimethylolpropane tri(acryloyloxypropyl) ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, polyester acrylate oligomer, 2-phenoxyethyl acrylate, 2-phenoxyethyl acrylate, phenol ethoxylate monoacrylate, 2-(p-chlorophenoxy)ethyl acrylate, p-chlorophenyl acrylate, phenyl acrylate, 2-phenylethyl acrylate, (2-acryloxyethyl) ether of bisphenol A, ethoxylated bisphenol A diacrylate, 2-(1-naphthyloxy)ethyl acrylate, o-biphenyl acrylate, o-biphenyl acrylate, 9,9-bis(4-acryloxydiethoxyphenyl)fluorene, 9,9-bis(4-acryloxytriethoxyphenyl)fluorene, 9,9-bis(4-acryloxydipropoxyphenyl)fluorene, 9,9-bis(4-acryloxyethoxy-3-methylphenyl)fluorene, 9,9-bis(4-acryloxyethoxy-3-ethylphenyl)fluorene, and 9,9-bis(4-acryloxyethoxy-3,5-dimethyl)fluorene.

Further, sulfur-containing acrylic compounds disclosed in Japanese Patent Laid-Open No. 72748/1986 may also be used. Examples thereof include, but are not limited to, 4,4′-bis(β-acryloyloxyethylthio)diphenylsulfone, 4,4′-bis(β-acryloyloxyethylthio)diphenylketone, 4,4′-bis(β-acryloyloxyethylthio)-3,3′,5,5′-tetrabromodiphenylket one, and 2,4-bis(β-acryloyloxyethylthio)diphenylketone.

Specific examples of methacrylic esters include such compounds that, among the above acrylic ester compounds, “methacrylate” has been substituted for “acrylate”, “methacryloxy” has been substituted for “acryloxy”, and “methacryloyl” has been substituted for “acryloyl”.

These photopolymerizable compounds may be used either solely or as a mixture of two or more.

The photopolymerizable compound is preferably added in an amount of 0.1 to 200 parts by weight, particularly preferably 10 to 150 parts by weight, based on 100 parts by weight of the acrylic copolymer resin.

The photopolymerization initiator may be properly selected according to the polymerization type of the above photopolymerizable compound. Photopolymerization initiators usable for photoradically polymerizable compounds include imidazole derivatives, bisimidazole derivatives, N-arylglycine derivatives, organic azide compounds, titanocenes, aluminate complexes, organic peroxides, N-alkoxypyridinium salts, and thioxanthone derivatives. More specific examples thereof include 1,3-di(t-butyldioxycarbonyl)benzophenone, 3,3′,4,4′-tetrakis(t-butyldioxycarbonyl)benzophenone, 3-phenyl-5-isoxazolone, 2-mercaptobenzimidazole, bis(2,4,5-triphenyl)imidazole, 2,2-dimethoxy-1,2-diphenylethan-1-one (tradename: Irgacure 651, manufactured by Ciba Specialty Chemicals, K.K.), 1-hydroxy-cyclohexyl-phenyl-ketone (tradename: Irgacure 184, manufactured by Ciba Specialty Chemicals, K.K.), 2-benzyl-2-dimethylamino-1-(4-morpholinophenyl)-butanone-1 (tradename: Irgacure 369, manufactured by Ciba Specialty Chemicals, K.K.), and bis(η5-2,4-cyclopentadien-1-yl)-bis(2,6-difluoro-3-(1H-pyrrol-1-yl)-phenyl)titanium (tradename: Irgacure 784, manufactured by Ciba Specialty Chemicals, K.K.). Aromatic iodonium salts, aromatic sulfonium salts, aromatic diazonium salts, aromatic phosphonium salts, triazine compounds and the like may also be used. Specific examples thereof include, but are not limited to: iodonium salts, for example, chlorides, bromides, borofluorides, hexafluorophosphates, and hexafluoroantimonates of iodonium, such as diphenyl iodonium, ditolyl iodonium, bis(p-tert-butylphenyl)iodonium, and bis(p-chlorophenyl)iodonium; sulfonium salts, for example, chlorides, bromides, borofluorides, hexafluorophosphates, and hexafluoroantimonates of sulfonium, such as triphenyl sulfonium, 4-tert-butyltriphenyl sulfonium, and tris(4-methylphenyl)sulfonium; and 2,4,6-substituted-1,3,5-triazine compounds, such as 2,4,6-tris(trichloromethyl)-1,3,5-triazine, 2-phenyl-4,6-bis(trichloromethyl)-1,3,5-triazine, and 2-methyl-4,6-bis(trichloromethyl)-1,3,5-triazine compounds.

These photopolymerization initiators are preferably added in an amount of 0.5 to 20 parts by weight, particularly preferably 1 to 15 parts by weight, based on 100 parts by weight of the acrylic copolymer resin.

A sensitizing dye may be further added from the viewpoint of improving the sensitivity of the photosensitive pressure-sensitive adhesive layer for the wavelength of a light source for sensitization.

Sensitizing dyes include thiopyrilium salt dyes, merocyanine dyes, cyanine dyes, quinoline dyes, cumarin dyes, ketocumarin dyes, xanthone dyes, thioxanthone dyes, rhodamine dyes, cyclopentanone dyes, and cyclohexanone dyes.

These sensitizing dyes are preferably added in an amount of 0.01 to 15 parts by weight, particularly preferably 0.1 to 5 parts by weight, based on 100 parts by weight of the acrylic copolymer resin.

Further, various plasticizers, surfactants and the like may be added from the viewpoints of controlling the adhesive strength and improving suitability for coating which will be described later.

The photosensitive pressure-sensitive adhesive layer is particularly preferably such that, upon exposure to light, the adhesive strength of the exposed part is lowered by not less than 50% as compared with the adhesive strength of the unexposed part. When this photosensitive pressure-sensitive adhesive layer is used, a good striped light shielding layer which will be described later can be formed. The adhesive strength is defined as a value determined by the 180-degree peel strength measurement specified in JIS Z 0237.

The photosensitive pressure-sensitive adhesive can be prepared by dissolving the acrylic copolymer resin, the photopolymerizable compound, the photopolymerization initiator, and optional additives such as room temperature crosslinking-type or heat crosslining-type crosslinking agent, the tackifier, and the sensitizing dye in a solvent. Solvents usable herein include methyl ethyl ketone, toluene, ethyl acetate, ethanol, and isopropanol. The solid content of the photosensitive pressure-sensitive adhesive is 15 to 50% by weight, preferably 20 to 35% by weight.

Further, a photosensitive pressure-sensitive adhesive layer may also be formed by coating the solvent-type pressure-sensitive adhesive directly onto the backside of a cylindrical lens film, or by the so-called “transfer method” in which the solvent-type pressure-sensitive adhesive is coated onto a separable substrate and the coating is then transferred.

Coating methods usable herein include conventional various coating methods, for example, die coating, Komma coating, knife coating, gravure coating, and roll coating. The thickness of the dried coating is preferably 4 to 30 μm, particularly preferably 5 to 25 μm.

The photosensitive pressure-sensitive adhesive layer may be formed by crosslinking treatment, that is, by aging treatment under room temperature conditions in the case of the room temperature crosslinking type or by heating to the above-described temperature in the case of the heat crosslinking type.

The separable substrate used in the transfer method may be conventional release paper. Further, a release film prepared by subjecting the surface of a polyethylene terephthalae film to release treatment with a fluoro-release agent or a silicone release agent may also be used. The separable substrate on the side which is opposite to the pressure-sensitive adhesive layer side may be subjected to release treatment from the viewpoint of avoiding blocking caused by protrusion of the pressure-sensitive adhesive layer formed by coating.

When the resin composition for photosensitive pressure-sensitive adhesive layer formation is liquid, the composition as such may also be coated without the use of any solvent.

The coating is exposed to light at a collimation angle of not more than 10 degrees at least in a direction perpendicular to the cylindrical lenses. Exposure wavelength and dose may be determined by taking into consideration, for example, the composition, mixing amount, and coating thickness of the photosensitive pressure-sensitive adhesive and the thickness of the transparent or semitransparent sheet constituting the cylindrical lenses.

(5) Striped Light Shielding Part

The light shielding part (C) is in a stripe form with a width of not more than 130 μm. The light shielding part is formed on a focused light-impermeable region by transferring a light shielding layer transfer sheet, which will be described later, onto a photosensitive pressure-sensitive adhesive layer. Since the focused light-impermeable region is in a stripe form, the light shielding part also becomes a stripe form.

The pitch of the striped light shielding part is preferably 50 to 90% of the lens pitch. According to the present invention, since a light shielding part having this narrow pitch can be provided, a lenticular lens sheet which can provide high-quality image representation can be realized.

This light shielding part can easily be formed by utilizing a light shielding layer transfer sheet which will be described later.

(6) Light Shielding Layer Transfer Sheet

The light shielding layer transfer sheet comprises a light shielding layer stacked on a transfer sheet substrate. The transfer sheet substrate may be formed of various materials which have excellent mechanical strength and have heat resistance, chemical resistance, solvent resistance, flexibility and the like. Examples of such materials include: polyester resins such as polyethylene terephthalate, polybutylene terephthalate, polyethylene naphthalate, polyethylene terephthalate-isophthalate copolymer, and terephthalic acid-cyclohexanedimethanol-ethylene glycol copolymer; cellulosic films; polyamide resins; polyolefin resins; acrylic resins; vinyl resins; styrene resins; and polycarbonates.

The transfer sheet substrate may be formed of a copolymer resin composed mainly of these resins, or a mixture (including an alloy) of these resins or may be a laminate of a plurality of layers of them. The transfer sheet substrate may be either a stretched film or an unstretched film. However, a monoaxially or biaxially stretched film is suitable from the viewpoint of improving the strength. If necessary, the resin film may contain a filler, a plasticizer, an antistatic agent and the like.

The thickness of the light shielding layer transfer sheet substrate is generally 5 to 200 μm, particularly preferably 10 to 100 μm. When the thickness is less than 5 μm, the mechanical strength is unsatisfactory.

The light shielding layer comprises at least a light shielding pigment and a binder. The binder preferably has good transferability, that is, high-resolution transferability, and thermoplastic resins are preferable. Thermoplastic resins include vinyl chloride resins, acrylic resins, polyester resins, urethane resins, amide resins, and cellulosic resins.

The light shielding pigment is not particularly limited so far as the pigment has a light shielding property, and carbon black is preferred.

The light shielding layer is formed by coating a low-viscosity composition (ink) prepared by dissolving a binder such as an acrylic resin, a light shielding pigment and optional additives such as a dispersant, a plasticizer, and an antistatic agent in a solvent.

Coating methods usable herein include conventional printing or coating methods such as roll coating, reverse roll coating, gravure coating (gravure printing), gravure reverse coating, Komma coating, or screen printing.

Preferably, the above composition possesses high-resolution transferability and has a ratio between the light shielding pigment and other dried solid content of at least 1.5.

(7) Adhesive Layer

The adhesive layer (D) should be such that this layer can be formed of any material, can provide satisfactory adhesive strength of the support (E) to the light shielding part (C) and the pressure-sensitive adhesive layer (B), and has no substantially adverse effect on function, properties and the like of the lenticular lens sheet. The material for constituting the adhesive layer can be selected by taking into consideration, for example, materials of the support (E), the light shielding part (C), and the pressure-sensitive adhesive layer (B) and the adhesive strength. For example, urethane resins, acrylic resins, and epoxy resins are usable. The bonding method may be properly selected from a holt melting method, a heat setting method, an ionizing radiation curing method, a tackifying method and the like. If necessary, a light diffusing agent may be added.

(8) Support

The support (E) preferably does not substantially have an adverse effect on function, properties and the like of the lenticular lens sheet and can retain its shape. Specific examples of materials for the support (E) include methyl methacrylate-styrene copolymer resins (MS resins), methacrylic resins, methyl methacrylate-butadiene-styrene copolymer resins (MBS resins), polycarbonate, polystyrene, polyvinyl chloride, and butadiene-styrene copolymer resins.

If necessary, for example, light diffusing properties, antireflection properties, antistatic properties, contamination preventive properties, and scratch resistance properties may be imparted.

5. Production Process of Lenticular Lens Sheet for Transmission Screen According to Fourth Aspect of Invention

The production process according to the present invention comprises the following steps (a) to (f). Each step will be described.

(1) Step (a)

In step (a), a shaping pattern is transferred onto a molten extruded thermoplastic resin to prepare a not more than 200 μm-thick transparent or semitransparent sheet (A) with cylindrical lenses being shaped therein at a pitch of not more than 150 μm.

In the apparatus shown in FIG. B2, for example, the thermoplastic resin is introduced in a pellet form from a hopper (15) into a barrel (16) where the thermoplastic resin is heated to a predetermined temperature. The heated thermoplastic resin is allowed to flow through a die (17). The flowed thermoplastic resin (11) is passed through a press contact point (19) between a pressing roll (18) and a molding roll (12), and is moved according to the rotation of the molding roll (12). The surface of the molding roll (12) has a predetermined shaped pattern (12a), and the thermoplastic resin (11) is shaped by the shaped pattern (12a) into a cylindrical lens shape. The sheet (13) shaped into the cylindrical lenses is applied to step (b).

When a substrate film layer is provided, as shown in FIG. B5, a substrate film (10) is supplied to the pressing roll (18).

(2) Step (b)

In step (b), a photosensitive pressure-sensitive adhesive layer (B) is formed on the transparent or semitransparent sheet (13, A), formed in step (a), on the flat side which is opposite to the cylindrical lenses.

FIG. B3 shows an embodiment of the sheet prepared in step (b). A photosensitive pressure-sensitive adhesive layer (B) is provided on the transparent or semitransparent sheet (A), composed of a cylindrical lens layer (A1) and a substrate film layer (A2), in the flat side which is opposite to the cylindrical lenses.

Details of the method for the formation of the photosensitive pressure-sensitive adhesive layer (B) are as described above.

(3) Step (c)

In step (c), light is applied at a collimation angle of not more than 10 degrees to the sheet, prepared in step (b), on its side where the cylindrical lenses are formed, whereby the adhesive strength of the photosensitive pressure-sensitive adhesive in its part exposed to light focused by the cylindrical lenses is lowered by a radical reaction.

The collimation angle is determined by taking into consideration, for example, a desired width of the light shielding part and exposure sensitivity of the photosensitive pressure-sensitive adhesive. Preferably, however, the collimation angle is not more than 5 degrees. Since the exposed part in the photosensitive pressure-sensitive adhesive layer (B) is in a stripe form, the photosensitive pressure-sensitive adhesive layer (B) in its adhesive strength lowered parts also become the same stripe form.

(4) Steps (d) to (f)

In step (d), a light shielding layer transfer sheet comprising a material for light shielding part formation is laminated onto the photosensitive pressure-sensitive adhesive layer in the sheet prepared in step (c). In step (e), the light shielding layer transfer sheet laminated in step (d) is separated to transfer the material for light shielding part formation onto the unexposed part in the photosensitive pressure-sensitive adhesive layer (B), thereby forming a striped light shielding part. These steps (d) and (e) can provide, for example, a sheet as shown in FIG. B4. Details of the method for the formation of the striped light shielding part by steps (d) and (e) are as described above.

In step (f), an adhesive layer (D) and a transparent or semitransparent support (E) formed of a thermoplastic resin are formed on the sheet prepared in step (e).

Step (f) can provide a lenticular lens sheet for a transmission screen according to the present invention shown, for example, in FIG. B1.

### EXAMPLES

The following Examples further illustrate the present invention but do not limit the present invention.

### Example A1

Pellets of a methacryl-butadiene-styrene copolymer resin (MBS) having a softening temperature of 98° C. were introduced into a hopper of an extrusion embossing apparatus shown in FIG. A7.

This apparatus was provided with a barrel which had been divided into six parts. The temperatures of the six parts were set respectively to 165° C., 205° C., 210° C., 240° C., 250° C., and 250° C. successively in that order from the part closest to the hopper to the part farthest from the hopper. The temperature of the die part was set to 250° C. The molten MBS was supplied through this die and extruded onto a substrate film (a transparent polyester film (PET film), thickness 50 μm), followed by embossing. At that time, the molding roll temperature was set to 80° C.

In this case, the take-off speed of the substrate film was 3 m/min.

Molding under the above conditions provided an optical sheet (total thickness 150 μm) according to the present invention having a cylindrical lens layer with a pitch of 140 μm and a thickness of 100 μm.

A photosensitive pressure-sensitive adhesive containing a radical reaction initiator was coated to a thickness of 20 μm onto the optical sheet prepared above on the side which is opposite to the cylindrical lenses. A parallel light radiation was applied at an exposure corresponding to 200 mJ/cm² to the sheet thus obtained on its cylindrical lens face side. The coating of the photosensitive pressure-sensitive adhesive only in its sites through which the radiation focused by the effect of the lenticular lens shape had been passed as the light path was cured, and the unexposed parts remained in a tacky state. A black transfer material was applied to the pressure-sensitive adhesive surface in this state, and transfer operation was carried out at a transfer temperature of 60° C. under a pressure of 2 kg/cm², followed by the separation of the transfer material from the photosensitive tacky surface. Thus, the black transfer material layer was adhered onto the pressure-sensitive adhesive only in its unexposed parts to produce a sheet comprising a striped light shielding layer.

Further, an acrylic resin adhesive was coated to a thickness of 50 μm onto the light shielding layer side of this sheet, and a support (thickness 2 mm) was then stacked on the coating to produce an optical sheet A1. This support is formed of an MS material containing 0.08% by weight of a styrene diffusing agent having an average particle diameter of 10 μm and has a light diffusing property.

### Example A2

Under the same temperature conditions and take-off speed conditions as in Example A1, the same resin as used in Example A1 was extruded on the substrate film followed by embossing. Thereafter, the substrate film was separated to produce a sheet provided with cylindrical lenses with a pitch of 90 μm and a thickness of 125 μm.

Further, in the same manner as in Example A1, a photosensitive pressure-sensitive adhesive containing a radical reaction initiator was coated to a thickness of 20 μm. A parallel light radiation was applied at an exposure corresponding to 150 mJ/cm² to the sheet thus obtained on its cylindrical lens face side. The coating of the photosensitive pressure-sensitive adhesive only in its sites through which the radiation focused by the effect of the lenticular lens shape had been passed as the light path was cured, and the unexposed parts remained in a tacky state. A black transfer material was applied to the pressure-sensitive adhesive surface in this state, and transfer operation was carried out at a transfer temperature of 60° C. under a pressure of 2 kg/cm², followed by the separation of the transfer material from the photosensitive tacky surface. Thus, the black transfer material layer was adhered onto the pressure-sensitive adhesive only in its unexposed parts to produce a sheet comprising a striped light shielding layer.

Further, an acrylic resin adhesive was coated to a thickness of 50 μm onto the light shielding layer side of this sheet, and a support (thickness 2 mm) was then stacked on the coating to produce an optical sheet A2. This support is formed of an MBS material with a surface subjected to an antiscratch treatment.

### Example B1

MBS pellets having a softening temperature of 98° C. were introduced into a hopper of an extrusion embossing apparatus shown in FIG. B2.

This apparatus was provided with a barrel which had been divided into six parts. The temperatures of the six parts were set respectively to 165° C., 205° C., 225° C., 250° C., 250° C., and 250° C. successively in that order from the part closest to the hopper to the part farthest from the hopper. The temperature of the die part was set to 250° C. The molten MBS was extruded through this die into between a molding roll with cylindrical shapes engraved at a pitch of 140 μm and a nip roll and was embossed. At that time, the molding roll temperature was set to 80° C. The take-off speed was 3 m/min.

Molding under the above conditions provided a transparent sheet (total thickness 170 μm) having, on its one side, cylindrical lenses with a pitch of 140 μm and a thickness of 40 μm.

An acrylic photosensitive pressure-sensitive adhesive (tradename: SW-22, manufactured by Soken Chemimal Engineering Co., Ltd.) was coated onto the transparent sheet on the side which is opposite to the cylindrical lenses to a thickness of 20 μm on a dry basis, and a separate film was applied to the photosensitive pressure-sensitive adhesive face.

The peel strength of this photosensitive pressure-sensitive adhesive was measured by the following method and was found to be 550 gf/inch in an unexposed state and 10 gf/inch after exposure.

Measurement of Peel Strength

1. A 100 μm-thick polyethylene terephthalate (PET) film one side of which had been subjected to corona treatment is provided. A photosensitive pressure-sensitive adhesive is coated onto the PET film on its corona-treated side to a thickness of 20 μm on a dry basis, and the coating is dried. Thereafter, a PET film with a surface subjected to release treatment is laminated onto the dried coating, and the assembly is aged at room temperature for one week.

2. Based on JIS Z 0237, a sample piece (width 1 inch) is applied to stainless steel (SUS 304), and the assembly is allowed to stand at room temperature for 24 hr. Thereafter, the peel strength in an unexposed state and the peel strength after exposure at 200 mJ/cm² are measured.

Ultraviolet light with wavelengths including a wavelength of 365 nm was applied at 150 mJ/cm² and a collimation angle of 5 degrees from the cylindrical lens face side of the sheet thus obtained. The coating of the photosensitive pressure-sensitive adhesive only in its sites through which the ultraviolet light focused by the effect of the cylindrical lens shape had been passed as the light path caused a lowering-in adhesive strength, and the unexposed parts remained in a tacky state.

The separate film was separated, and a light shielding sheet was then applied to the surface of the pressure-sensitive adhesive. Lamination was carried out under conditions of temperature 80° C. and pressure 5 kg/cm². Thereafter, the light shielding sheet was separated from the surface of the photosensitive pressure-sensitive adhesive.

The light shielding sheet was prepared as follows. A 25 μm-thick PET film was provided as a light shielding layer transfer sheet substrate. The following composition (ink) for a light shielding layer was coated onto the substrate by gravure reverse coating at a coverage of 1.0 g/m² on a dry basis, and the coating was dried to form a light shielding layer. Thus, a light shielding sheet was prepared.

The composition (ink) for a light shielding layer was prepared by dispersing and dissolving 10 parts by mass of an acrylic resin, 20 parts by mass of carbon, and 2 parts by mass of a dispersant in 68 parts by mass of a mixed solvent composed of equal amounts of toluene and methyl ethyl ketone.

Thus, the black ink was adhered only onto the unexposed part of the pressure-sensitive adhesive to form a striped light shielding layer.

Further, an acrylic adhesive was coated to a thickness of 50 μm onto the light shielding layer side of the optical sheet. Subsequently, a support (thickness 2 mm) was stacked on the coating to produce a lenticular lens sheet B1 for a transmission screen. This support is formed of an MS material containing 0.08% by weight of a styrene diffusing agent having an average particle diameter of 10 μm and has a light diffusing property.

### Example B2

In the same material, extruder, and temperature conditions as in Example B1, extrusion and embossing were carried out between a molding roll with cylindrical shapes engraved at a pitch of 90 μm and a nip roll. At that time, the take-off speed was 5 m/min. In this case, any substrate film was not used.

Molding under the above conditions provided a 130 μm-thick transparent sheet having, on its one side, cylindrical lenses with a pitch of 90 μm and a height of 25 μm.

A photosensitive pressure-sensitive adhesive was coated by die coating onto a separate film to a thickness of 20 μm, and this sheet was applied to the transparent sheet on the side which is opposite to the cylindrical lenses. The photosensitive pressure-sensitive adhesive was the same as that used in Example B1.

Ultraviolet light with wavelengths including a wavelength of 365 nm was applied at 100 mJ/cm² and a collimation angle of 5 degrees from the cylindrical lens face side of the sheet thus obtained. The coating of the photosensitive pressure-sensitive adhesive only in its sites through which the ultraviolet light focused by the effect of the cylindrical lens shape had been passed as the light path caused a lowering in adhesive strength, and the unexposed parts remained in a tacky state.

The separate film was separated, and a light shielding sheet was then applied to the surface of the pressure-sensitive adhesive. Lamination was carried out under conditions of temperature 80° C. and pressure 5 kg/cm². Thereafter, the light shielding sheet was separated from the surface of the photosensitive pressure-sensitive adhesive. The light shielding sheet was the same as that used in Example B1.

Thus, the black ink was adhered only onto the unexposed part of the pressure-sensitive adhesive to form a striped light shielding layer.

Further, an acrylic adhesive was coated to a thickness of 50 μm onto the light shielding layer side of the optical sheet. Subsequently,

a support (thickness 2 mm) was stacked on the coating to produce a lenticular lens sheet B2 for a transmission screen. This support is formed of an MS material having a surface subjected to antiscratch treatment and antireflection treatment.

1. An optical sheet comprising an optical function layer formed of a thermoplastic resin,
said optical function layer having been formed by shaping the surface of the thermoplastic resin into cylindrical lenses, the pitch of the shaped cylindrical lenses being not more than 150 μm.

2. The optical sheet according to claim 1, which further comprises a substrate film layer.

3. The optical sheet according to claim 1, wherein said optical function layer has a thickness of not more than 200 μm, preferably not more than 150 μm.

4. The optical sheet according to claim 1, wherein said thermoplastic resin has a softening temperature of 80 to 180° C.

5. The optical sheet according to any one of claims 1 to 4, which further comprises, on the side which is opposite to the cylindrical lenses, a striped light shielding layer directly or through a pressure-sensitive adhesive layer.

6. The optical sheet according to claim 5, wherein a support is provided on the striped light shielding layer directly or through an adhesive layer.

7. The optical sheet according to claim 6, wherein said support has a saturated water absorption elongation of not more than 0.3%.

8. Use of the optical sheet according to claim 1 in a transmission screen light diffusing sheet.

9. A process for producing the optical sheet according to claim 2, said process comprising the steps of:
a) extruding and delivering a molten thermoplastic resin continuously onto a substrate film being moved;
b) pressing a molding roll against the thermoplastic resin provided on the substrate film to transfer a shaping pattern on the surface of the molding roll onto the thermoplastic resin and thus to shape the surface of the thermoplastic resin into cylindrical lenses, and continuously delivering a laminate structure of the shaped thermoplastic resin and the substrate film; and
c) subsequently curing the shaped thermoplastic resin and then separating the substrate film from the assembly to produce said optical sheet or providing said optical sheet without the separation of the substrate film.

10. A lenticular lens sheet for a transmission screen, said lenticular lens sheet comprising (A) a transparent or semitransparent sheet formed of a thermoplastic resin, (B) a photosensitive pressure-sensitive adhesive layer, (C) a light shielding part, (D) an adhesive layer, and (E) a transparent or semitransparent support formed of a thermoplastic resin which have been successively formed in that order,
said sheet (A) having cylindrical lenses with a pitch of not more than 150 μm on one side of the sheet, and having a sheet thickness of not more than 200 μm,
said light shielding part (C) being in the form of a stripe having a width of not more than 130 μm.

11. The lenticular lens sheet for a transmission screen according to claim 10, wherein said photosensitive pressure-sensitive adhesive layer (B) is formed of a photosensitive adhesive that, upon a radical reaction, undergoes a lowering in adhesive strength at its exposed part.

12. The lenticular lens sheet for a transmission screen according to claim 11, wherein the adhesive strength of said photosensitive pressure-sensitive adhesive in its exposed part is lower by not less than 50% than the unexposed part.

13. The lenticular lens sheet for a transmission screen according to claim 10, wherein said sheet (A) comprises a substrate film layer and a cylindrical lens layer.

14. The lenticular lens sheet for a transmission screen according to claim 10, wherein said photosensitive pressure-sensitive adhesive layer (B) comprises a photosensitive pressure-sensitive adhesive resin composition comprising at least an acrylic ester pressure-sensitive adhesive resin, a photoradically polymerizable compound, or a photoradical polymerization initiator system.

15. The lenticular lens sheet for a transmission screen according to claim 10, wherein said light shielding part (C) contains a light shielding pigment and the content of the light shielding pigment in the light shielding part is at least 1.5 times larger than other solid contents contained in the light shielding part.

16. A process for producing the lenticular lens sheet for a transmission screen according to claim 10, said process comprising the steps of:
a) transferring a shaping pattern onto a molten extruded thermoplastic resin to prepare a not more than 200 μm-thick transparent or semitransparent sheet (A) with cylindrical lenses being shaped therein at a pitch of not more than 150 μm;
b) forming a photosensitive pressure-sensitive adhesive layer (B) on the transparent or semitransparent sheet (A), formed in step (a), on the flat side which is opposite to the cylindrical lenses;
c) applying light at a collimation angle of not more than 10 degrees to the sheet, prepared in step (b), on its side where the cylindrical lenses are formed, whereby the adhesive strength of the photosensitive pressure-sensitive adhesive in its part exposed to light focused by the cylindrical lenses is lowered by a radical reaction;
d) laminating a light shielding layer transfer sheet comprising a material for light shielding part formation onto the photosensitive pressure-sensitive adhesive layer in the sheet prepared in step (c);
e) separating the light shielding layer transfer sheet laminated in step (d) to transfer the material for light shielding part formation onto the unexposed part in the photosensitive pressure-sensitive adhesive layer (B), thereby forming a striped light shielding part; and
f) forming an adhesive layer (D) and a transparent or semitransparent support (E) formed of a thermoplastic resin on the sheet prepared in step (e).
